(19) United States
(12) Patent Application Publication
(10) Pub. No.: US 2019/0017285 A1
(43) Pub. Date: Jan. 17, 2019

(54) Lattice Support System

(71) Applicant: JoAnn Kain, Aransas Pass, TX (US)

(72) Inventor: JoAnn Kain, Aransas Pass, TX (US)

(21) Appl. No.: 15/651,794

(22) Filed: Jul. 17, 2017

(51) Int. Cl. E04H 12/22; A01G 17/06; E04H 12/34

(52) U.S. Cl. CPC E04H 12/2269; E04H 12/347; E04H 12/2292; A01G 17/06

(57) ABSTRACT

A lattice support system for retaining a plant lattice in a vertical orientation includes a plant lattice that has a pair of legs. A pair of tubes is provided and each of the tubes is inserted into ground having the tubes being vertically oriented. Each of the tubes insertably receives an associated one of the legs. In this way the plant lattice is retained in a vertical orientation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to support devices and more particularly pertains to a new support device for retaining a plant lattice in a vertical orientation.

### BRIEF SUMMARY OF THE INVENTION

An embodiment of the disclosure meets the needs presented above by generally comprising a plant lattice that has a pair of legs. A pair of tubes is provided and each of the tubes is inserted into ground having the tubes being vertically oriented. Each of the tubes insertably receives an associated one of the legs. In this way the plant lattice is retained in a vertical orientation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tube of a lattice support system according to an embodiment of the disclosure.

FIG. 2 is a top view of a tube of an embodiment of the disclosure.

FIG. 3 is a perspective in-use view of an embodiment of the disclosure.

FIG. 4 is an exploded perspective view of an embodiment of the disclosure.

FIG. 5 is a cross sectional view taken along line 5-5 of FIG. 3 of an embodiment of the disclosure.

### DETAILED DESCRIPTION OF THE INVENTION

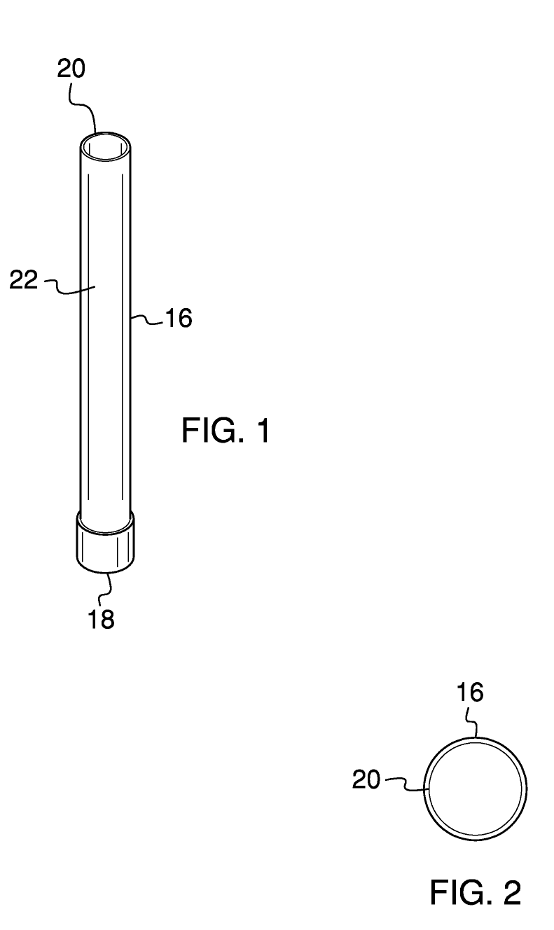

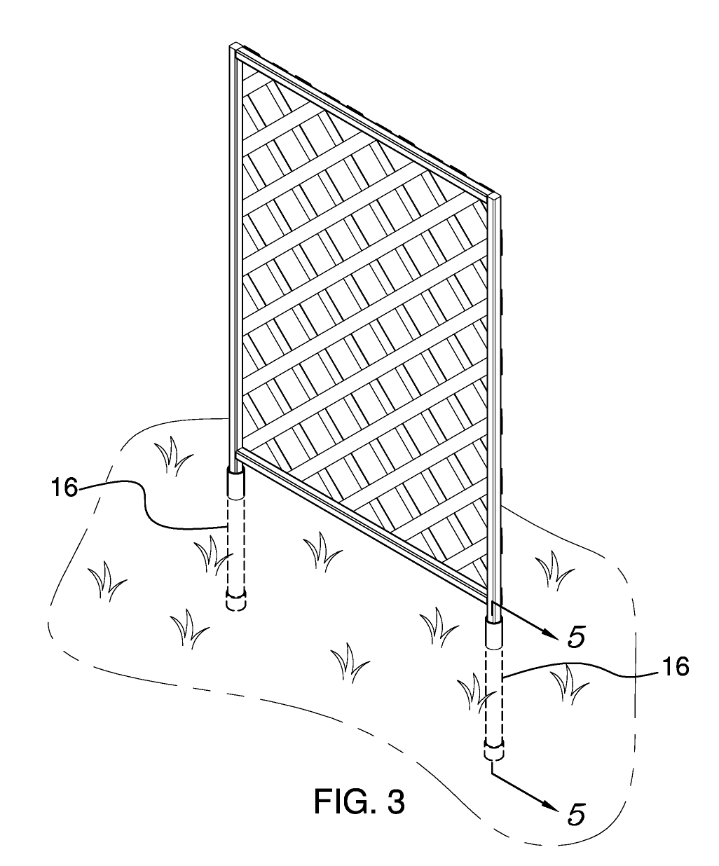

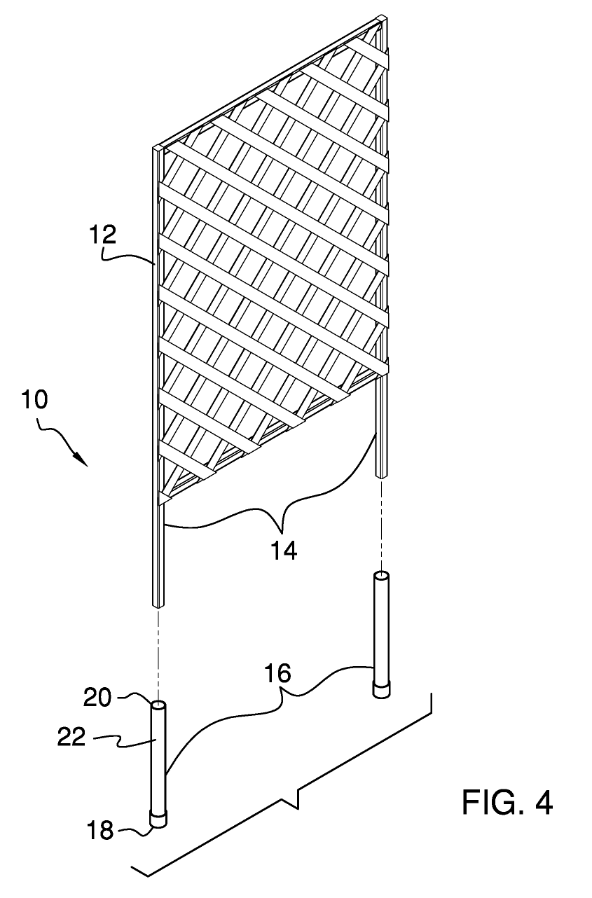

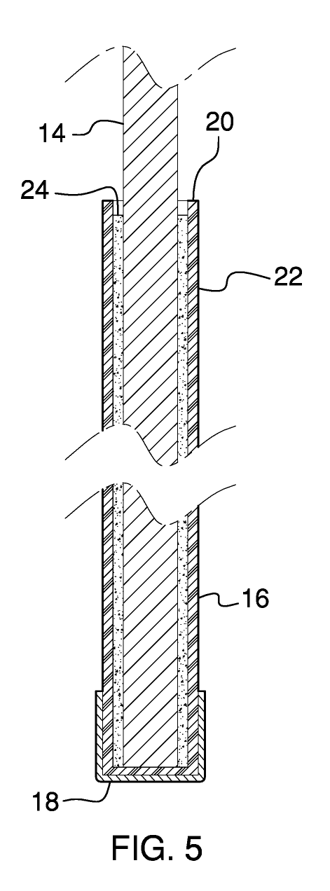

With reference now to the drawings, and in particular to FIGS. 1 through 5 thereof, a new support device embodying the principles and concepts of an embodiment of the disclosure and generally designated by the reference numeral 10 will be described.

As best illustrated in FIGS. 1 through 5, the lattice support system 10 generally comprises a plant lattice 12 that has a pair of legs 14. The plant lattice 12 may be a wooden lattice, a composite lattice and any other conventional type of plant lattice 12. Additionally, the plant lattice 12 may be employed to facilitate plants to climb the plant lattice 12. A pair of tubes 16 is provided and each of the tubes 16 is inserted into ground having the tubes 16 being vertically oriented. Each of the tubes 16 insertably receives an associated one of the legs 14 such that the plant lattice 12 is retained in a vertical orientation.

Each of the tubes 16 has a first end 18, a second end 20 and an outer wall 22 extending therebetween. The first end 18 is closed and the second end 20 is spaced from the ground when the tubes 16 are inserted into the ground. The second end 20 of each of the tubes 16 receives the associated leg. Each of the tubes 16 may have a length ranging between approximately 35.0 cm and 45.0 cm and a diameter ranging between approximately 5.0 cm and 8.0 cm. Each of the tubes 16 is comprised of a fluid impermeable material to inhibit fluid from contacting the legs 14. In this way the tubes 16 protect the legs 14 from rotting when the plant lattice 12 is constructed of wood. Each of the tubes 16 is comprised of a rigid material such as polyvinyl chloride or the like. Thus, the outer wall 22 corresponding to each of the tubes 16 protects the associated leg from being contacted by lawn care equipment thereby enhancing a service life of the plant lattice 12.

A liquid cement 24 is provided and the liquid cement 24 is selectively poured into each of the tubes 16 when the associated legs 14 are inserted into the tubes 16. The liquid cement 24 cures into a hardened cement when the liquid cement 24 has been exposed to air for a minimum duration of time. Thus, the hardened cement inhibits the plant lattice 12 from being urged out of the vertical orientation. The liquid cement 24 may be a polyurethane sealant, such as np1 caulk or the like, that is fluid impermeable when the liquid cement 24 cures into the hardened cement.

In use, a pair of holes is dug into the ground and each of the tubes 16 is inserted into the holes. Each of the tubes 16 is positioned such that the second end 20 corresponding to each of the tubes 16 is spaced approximately 5 cm above the ground. Each of the legs 14 on the plant lattice 12 is inserted into the second end 20 of the associated tube. The liquid cement 24 is poured into each of the tubes 16 to completely fill each of the tubes 16. The liquid cement 24 cures into the hardened cement to retain the plant lattice 12 in each of the tubes 16.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lattice support system comprising:
a plant lattice having a pair of legs; and
a pair of tubes, each of said tubes being configured to be inserted into ground having said tubes being vertically oriented, each of said tubes insertably receiving an associated one of said legs such that said plant lattice is retained in a vertical orientation.

2. The system according to claim 1, wherein each of said tubes has a first end, a second end and an outer wall extending therebetween, said first end being closed, said second end being configured to be spaced from the ground when said tubes are inserted into the ground, said second end of each of said tubes receiving said associated leg.

3. The system according to claim 2, wherein each of said tubes is comprised of a fluid impermeable material wherein each of said tubes is configured to inhibit fluid from contacting said legs.

4. The system according to claim 2, wherein each of said tubes is comprised of a rigid material wherein said outer wall corresponding to each of said tubes is configured to protect said associated leg from being contacted by lawn care equipment thereby enhancing a service life of said plant lattice.

5. The system according to claim 1, further comprising a liquid cement being selectively poured into each of said tubes when said associated legs are inserted into said tube.

6. The system according to claim 5, wherein said liquid cement cures into a hardened cement such that said hardened cement inhibits said plant lattice from being urged out of said vertical orientation.

7. A lattice support system comprising:
a plant lattice having a pair of legs;
a pair of tubes, each of said tubes being configured to be inserted into ground having said tubes being vertically oriented, each of said tubes insertably receiving an associated one of said legs such that said plant lattice is retained in a vertical orientation, each of said tubes having a first end, a second end and an outer wall extending therebetween, said first end being closed, said second end being configured to be spaced from the ground when said tubes are inserted into the ground, said second end of each of said tubes receiving said associated leg, each of said tubes being comprised of a fluid impermeable material wherein each of said tubes is configured to inhibit fluid from contacting said legs, each of said tubes being comprised of a rigid material wherein said outer wall corresponding to each of said tubes is configured to protect said associated leg from being contacted by lawn care equipment thereby enhancing a service life of said plant lattice; and
a liquid cement being selectively poured into each of said tubes when said associated legs are inserted into said tubes, said liquid cement curing into a hardened cement such that said hardened cement inhibits said plant lattice from being urged out of said vertical orientation.
